(19) United States
(12) Patent Application Publication
(10) Pub. No.: US 2023/0249431 A1
(43) Pub. Date: Aug. 10, 2023

(54) APPARATUS AND METHOD FOR MANUFACTURING A TISSUE PAPER PRODUCT

(71) Applicant: Essity Hygiene and Health Aktiebolag, Goteborg (SE)

(72) Inventors: Donald Barredo, Kunheim (FR); Benoit Arnoul-Jarriault, Kunheim (FR)

(21) Appl. No.: 18/012,966

(22) PCT Filed: Jul. 3, 2020
(86) PCT No.: PCT/IB2020/000586

§ 371 Date: Dec. 26, 2022

(51) Int. Cl. B31F 1/07

(52) U.S. Cl. CPC B31F 1/07; B31F 2201/0723; B31F 2201/0756; B31F 2201/0764; B31F 2201/0766; B31F 2201/0782; B31F 2201/0787

(57) ABSTRACT

This disclosure relates to an apparatus for manufacturing a tissue paper product, such as toilet paper or household towel. The apparatus comprises an embossing unit comprising a first counter roll, a first heatable embossing roll, a second counter roll, and a second heatable embossing roll, and a marrying roll. The apparatus is configured to emboss a first ply between the first heatable embossing roll and the first counter roll, to emboss a second ply between the second heatable embossing roll and the second counter roll, and to ply-bond the first ply and the second ply between the first heatable embossing roll and the marrying roll.

### CROSS REFERENCE TO RELATED APPLICATION

This application is a National Stage application of PCT/IB2020/000586, filed Jul. 3, 2020, which is incorporated by reference in its entirety herein.

### TECHNICAL FIELD

The present disclosure relates to an apparatus and to a method for manufacturing a tissue paper product, such as toilet paper or household towel, as well as to products manufactured using said apparatus and/or said method.

### TECHNICAL BACKGROUND

In the following, a “tissue paper product” relates to an absorbent paper based on cellulose wadding. The latter is also referred to as a tissue paper base-sheet in this field of technology.

Fibres contained in a tissue paper product are mainly cellulosic fibres, such as pulp fibres from chemical pulp (e.g. Kraft or sulphite), mechanical pulp (e.g. ground wood), thermo-mechanical pulp, chemo-mechanical pulp and/or chemo-thermo-mechanical pulp (CTMP). Pulps derived from both deciduous (hardwood) and coniferous (softwood) can be used. Fibres may also come from non-wood plants, e.g., cereal, bamboo, jute, and sisal. The fibres or a portion of the fibres may be recycled fibres, which may belong to any or all of the above categories. The fibres can be treated with additives, e.g. fillers, softeners, such as, but not limited to, quaternary ammonium compounds and binders, conventional dry-strength agents, temporary wet strength agents or wet-strength agents, in order to facilitate the original paper making or to adjust the properties thereof. The tissue paper product may also contain other types of fibres, e.g., regenerated cellulosic fibres or synthetic fibres for enhancing, for instance, strength, absorption, smoothness or softness of the tissue paper product.

Tissue paper products may be used for personal and household use as well as for commercial and industrial use. They may be adapted to absorb fluids, remove dust, and for other cleaning purposes. If tissue paper is to be made out of pulp, the process essentially comprises a forming step that includes a headbox-and a forming wire section, and a drying section, either through air drying or conventional drying on a Yankee cylinder. The production process may also include a crepe and, finally, typically a monitoring and winding step.

Several plies may be combined together by a combining operation of a chemical nature (e.g., by adhesive bonding), or of a mechanical nature (e.g., by knurling or so-called edge-embossing), or a combination of both.

Further, the processing to finished tissue product may involve, e.g., longitudinal cut, folding, cross cut, etc. Moreover, individual tissue products may be positioned and brought together to form stacks, which may be individually packaged. Such processing steps may also include application of substances like scents, lotions, softeners or other chemical additives.

When several plies are combined together using adhesive bonding, a film of adhesive is deposited over some or all of the surface of at least one of the plies, then the adhesive-treated surface is placed in contact with the surface of at least one other ply.

When several plies are combined together using mechanical bonding, the plies may be combined by knurling, by compression, by edge-embossing, union embossing and/or ultrasonic.

Mechanical and adhesive bonding may also be combined to combine several plies.

The processing step from the base tissue to a finished tissue paper product occurs in processing machines (converting machines) which include operations such as unwinding the base tissue, calendaring of the tissue, laminating, printing or embossing together to form a multi-ply product.

Embossing can be used to change the shape of a ply from flat to shaped, so that there are areas that are raised and/or recessed from the rest of the surface. It therefore constitutes a deformation of the previously flat sheet, and results in a ply having a particular relief. Usually, the thickness of the ply or of the multiple plies is increased after embossing compared with its initial thickness.

An embossing process is carried out between an embossing roll and a counter roll. The embossing roll can have protrusions or depressions on its circumferential surface leading to embossed protrusions/depressions in the paper web. Counter rolls may be softer than the corresponding embossing roll and may consist of rubber, such as natural rubber, or plastic materials, paper or steel. If the counter roll is made of a softer material like rubber, a contact area/nip can be formed between the embossing roll (e.g., steel roll) and the counter roll by the deformation of the softer roll.

By embossing, a pattern can be applied to a tissue paper fulfilling a decorative and/or functional purpose. A functional purpose may be to improve the properties of the hygiene paper product, that is, the embossment may improve the product thickness, absorbency, bulk, softness, etc. A functional purpose may also be to provide a joint to another ply in a multi-ply product.

Another type of embossment is referred to herein as a “pre-embossment”. A pre-embossment could optionally be applied to a web or ply prior to its joining to the other plies of a multi-ply tissue product.

Such pre-embossment may be made for a functional purpose e.g. as laid out in the above to increase the thickness of the ply, the absorbency, bulk and/or softness.

“Micro-embossment” is used herein for an embossment pattern with a dense configuration. Typically, the micro-embossment may comprise dots in the range 25 to 100 dots per cm², optionally 40 to 100 dots per cm² or 50 to 80 dots per cm². A micro-embossment may advantageously be a pre-embossment. The micro-embossed dots may have different relatively simple surface shapes such as circles, ovals, squares, rectangles or diamonds.

Although the apparatuses and methods for production of tissue paper products proposed in the past may be very useful in many applications, there is still a need for improvements. Such improvements would be desirable particularly in terms of being able to produce products with sufficient thickness, softness, and tensile strength and with good absorption capacity.

There is, hence, a desire for an improved manufacturing apparatuses and methods offering to achieve an improvement in at least one of the above-mentioned properties of tissue paper products.

### SUMMARY

Aspects of the above-mentioned object are achieved by an apparatus for manufacturing a tissue paper product, such as toilet paper or household towel in accordance with the present disclosure.

One aspect of the present disclosure relates to an apparatus for manufacturing a tissue paper product, such as toilet paper or household towel, the apparatus comprising an embossing unit with a first counter roll, a first heatable embossing roll, a second counter roll, and a second heatable embossing roll, and a marrying roll.

The apparatus is configured to emboss a first ply between the first heatable embossing roll and the first counter roll, to emboss a second ply between the second heatable embossing roll and the second counter roll, and to ply-bond the first ply and the second ply between the first heatable embossing roll and the marrying roll.

The first heatable embossing roll and the second heatable embossing roll may be synchronizeable. The apparatus may, while use is made of the option of synchronizing the first heatable embossing roll and the second heatable embossing roll, ply-bond the first ply and the second ply with a nested embossment structure. Alternatively, according to some embodiments, the synchronization may be used to form a tip-to-tip bonding structure. According to some embodiments of the apparatus with synchronizeabble first and second heatable embossing rolls, the apparatus may allow manufacturing without synchronizing the first and second heatable embossing rolls. In this case, the ply-bonding of the first ply and second ply may, e.g. lead to a non- (or random) nested structure.

The nested embossment structure means that embossments of the first ply and embossments of the second ply are nested in one another, i.e., the synchronization of the first and second heatable embossment rolls allows to synchronize embossments on the first and second plies such that the ply-bonding (between the first heatable embossing roll and the marrying roll) produces the nested configuration.

The tip-to-tip bonding structure means that tips of embossment of neighboring plies are ply-bonded together.

During manufacturing, the two heatable embossing rolls can be heated, and the manufactured tissue paper products may, as a consequence of the heat-embossing (as opposed to embossing with a respective non-heated roll) have a higher strength, as compared to reference products manufactured using identical compounds and with the same product thickness, but with the only difference of using non-heated embossing rolls. Increases in strength may be in a range of 5-25%, or even in a range of about 20-25%. As compared to the reference products, a gain in absorption capacity may be reached. The gain may be about 15%. In addition, an increase in cross-directional (CD) tensile strength and/or main directional (MD) tensile strength may be achieved in the manufactured tissue paper products. The gain may, for CD and/or MD tensile strength, be about 5-10%. The softness of the product may not be decreased or only insignificantly decreased in comparison to the respective reference product.

Whenever reference is made to the “thickness” in this text, reference is made to the thickness as obtained in accordance with European standard EN 12625-3 using the Frank Thickness Gauge equipment (Model 16502) or the like. The tissue paper sheet to be measured is cut into pieces of minimum 80 mm in any direction and the pieces are conditioned at 23° C., 50% RH (Relative Humidity) for at least 2 hours. During measurement a sample piece is placed between a fixed bottom plate and a pressure foot. The pressure foot is then lowered at a speed of 2.0 mm/s. The thickness value for the sheet is then read after the pressure value is stabilized. The Essity Internal diameter of the pressure foot is 35.7 mm. The lower plate dimension is minimum 20% bigger. The pressure applied is 2.0 kPa during the measurement.

The first and second heatable embossing rolls may be at least in part spatially located between the first counter roll and the second counter roll.

The first heatable embossing roll may be heatable from the inside or outside by a heating means. A heating means may be provided inside of the first heatable embossing roll. In addition thereto or as an alternative, a heating means may be provided exterior to the first heatable embossing roll. Each of the heating means provided for the first heatable embossing roll may comprise heat carrying fluid and/or rely on induction and/or infrared heating.

The second heatable embossing roll may be heatable from the inside or outside by a heating means. A heating means may be provided inside of the second heatable embossing roll. In addition thereto or as an alternative, a heating means may be provided exterior to the second heatable embossing roll. Each of the heating means provided for the second heatable embossing roll may comprise heat carrying fluid and/or rely on induction and/or infrared heating.

The embossing unit may be configured to receive the first ply with the first counter roll, to convey the first ply between the first counter roll and the first heatable embossing roll, and to further convey the first ply with the first heatable embossing roll. Based on this setup, a first ply may travel to the first counter roll, then pass between the first counter roll and the first heatable embossing roll, and then be further conveyed by the first heatable embossing roll towards the position where it is ply-bonded together with a second ply between the first heatable embossing roll and the marrying roll.

The embossing unit may be configured to receive the second ply with the second counter roll, to convey the second ply between the second counter roll and the second heatable embossing roll, and to further convey the second ply with the second heatable embossing roll. Based on this setup, a second ply may travel to the second counter roll, then pass between the second counter roll and the second heatable embossing roll, and then be further conveyed by the second heatable embossing roll towards the position where it is ply-bonded together with a first ply between the first heatable embossing roll and the marrying roll.

The embossing unit may be configured to convey the first ply and the second ply, after they have been embossed between the first and second heatable embossing rolls and the respective counter rolls, between the first heatable embossing roll and the marrying roll, in order for ply-bonding to take place.

This assembly of rolls with the described conveying path for the two plies may allow high speed production and good ply-bonding even while heat-embossing is carried, i.e., while the embossing is carried out at a high temperature prior to the ply-bonding step being carried out (i.e., heating the embossing rolls and embossing with heated embossing rolls).

The embossing unit may comprise an adhesive supplying unit for applying adhesive, such as lamination glue, to the first ply and/or to the second ply. The embossing unit may also comprise two adhesive supplying units, one for suppling adhesive to the first ply and one for the second ply, respectively, or even a larger number of adhesive supplying units.

The structural configuration of the embossing unit makes it possible to produce at high speed, combining the processes of supplying adhesive (optionally prior to the heat-embossing of the ply to which adhesive is supplied) and of ply-bonding sequentially within a short period of time.

Other embodiments may rely on using water to ply-bond plies. The embossing unit may, e.g., comprise a water supplying unit for supplying water for ply-bonding purposes. A bonding pressure applied to plies to be ply-bonded using water may be set higher than for embodiments in which plies are ply-bonding using an adhesive such as lamination glue.

According to some embodiments, the apparatus is configured to supply the adhesive to at least a part of the tips of embossments formed on the first ply or the second ply. Optionally, the adhesive may be supplied to at least 90%, optionally at least 95% or even 98% or 99% of all tips of one type of embossments formed on the first ply or the second ply (wherein the one type may be the only type of embossments formed on the ply or one of several, e.g., if double-height embossing is used, etc.).

The adhesive supplying unit may be configured to supply adhesive to the first ply while the first ply is being conveyed by the first heated embossing unit prior to the ply-bonding. Alternative or in addition thereto, the adhesive supplying unit may be configured to supply adhesive to the second ply while being conveyed by the second heated embossing unit prior to the ply-bonding.

According to some embodiments, the apparatus comprises an applicator roll for applying adhesive to a ply. The adhesive supplying unit may comprise the applicator roll. The applicator roll may be configured to transfer adhesive to the first ply and/or to the second ply.

The apparatus may comprise an anilox roll for dosing adhesive and transferring the adhesive to the applicator roll. The anilox roll may constitute a part of the adhesive supplying unit. The anilox roll may be engraved with cavities for receiving respective dosages of adhesive. Using the cavities of the anilox roll, a highly precise dosage of adhesive is enabled. The transfer onto the applicator roll before transferring to a ply may nevertheless allow a homogenous application of adhesive. In other words, the quantifying using the anilox roll combined with the homogenization by the applicator roll may allow to both achieve a very precise dosage of adhesive (discretizing the amounts using cavities) as well as homogeneity in applying the adhesive.

The cavities of the anilox roll may all have the same size, or the anilox roll may comprise cavities with different sizes, for either always receiving the same amount of adhesive or different amounts of adhesive. The “respective dosages” refer to the amount of adhesive that can be received in the respective cavity.

The adhesive supplying unit may comprise an adhesive storage part, such as a glue chamber, and the anilox roll may be configured to pick up adhesive from the adhesive storage part in its cavities.

The apparatus may be configured to process at a ply speed in a range of 200 m/min to 700 m/min. It may not be possible to successfully combine the supplying of adhesive with the heat-embossing using heated embossing rolls, if it were not for the high processing speed. In other words, the structural configuration of the nested embossing unit, together with the adhesive supplying unit, as well as the configuration to work at processing speeds of 200 m/min to 700 m/min may synergistically work together. In combination, these properties of the apparatus may allow increasing the strength of produced tissue paper products by about 5-25% or even 20-25% as compared to reference products. In addition or alternative thereto, a gain in absorption capacity of about 15% and/or an increase in cross-directional (CD) and or main-directional (MD) tensile strength of about 5-10% may be achieved, while (for each case) the softness of the product may not be decreased or only insignificantly decreased with respect to the respective reference product.

Whenever reference is made to the “softness” of a tissue paper product in this text, reference is made to the property of softness as determined through an evaluation by panel members. A panel of ten members was used in this case. Panel lists are used to rank products in terms of softness. Softness Panel values are used as comparative values enabling a comparison between tested samples. The softer the product/tissue paper product is, the higher the rated value. The softness scale was in the present case set from 0 to 10 (10 being the highest value). Each sample is composed of one product, i.e., a tissue paper product. Alternatively, each sample is a ply. Samples are first conditioned for a minimum of two hours in a controlled area at 23° C. and 50% relative humidity. Then, evaluation by the panel members takes place.

According to some embodiments, the adhesive supplying unit is configured to supply adhesive to the first ply while the first ply is being conveyed by the first heatable embossing roll. This may be particularly beneficial when combined with processing speeds between 200 m/min to 700 m/min (or, optionally, 300 m/min to 700 m/min, or even 400 m/min to 700 m/min), as the heating, gluing, and ply-bonding may all be mutually combined with high precision, speed, and reliability.

The first counter roll, the second heatable embossing roll, and the marrying roll may be rotatable in one direction, whereas the second counter roll and the first heatable embossing roll may be rotatable in another direction, opposite to the one direction. In addition thereto or alternatively, the first and second plies may be oriented such that the formed embossments point towards the respective opposing ply prior to the ply-bonding taking place between the first heatable embossing roll and the marrying roll. In other words, the rotation direction of the respective rolls is such that the plies are conveyed such that the tips of embossments poke towards the respective opposing ply with which a mating is to be effected during ply-bonding. This way, a reliable ply-bonding (e.g., using an adhesive) may be carried out between the first heatable embossing roll and the marrying roll.

According to some embodiments, the first heatable embossing roll is configured to form first embossments with a height in a range of 0.2 mm to 2.0 mm on the first ply. This means, in particular, that the first heatable embossing roll may comprise first embossing protrusions with a height in a range of 0.2 mm to 2.0 mm for forming the first embossments. The first heatable embossing roll may comprise different embossing protrusions with different heights for forming double height embossing, or more than two types of protrusions with different heights.

Embossing heights can be measured, e.g., indirectly on an embossing roll (by measuring embossing protrusion heights) or directly, e.g., using 3D tomography (e.g., using Alicona Infinite Focus SL).

According to some embodiments, the second heatable embossing roll is configured to form second embossments with a height in a range of 0.2 mm to 2.0 mm on the second ply. This means, in particular, that the second heatable embossing roll may comprise second embossing protrusions with a height in a range of 0.2 mm to 2.0 mm for forming the second embossments. The second heatable embossing roll may comprise different embossing protrusions with different heights for forming double height embossing, or more than two types of protrusions with different heights.

The height of the first embossments and the second embossments may differ or it may be identical. In other words, the height of the embossing protrusions on the first heatable embossing cylinder may differ from the height of the embossing protrusions on the second heatable embossing cylinder. Alternatively, the height of the at least some or of all of the protrusions on each of the first and second heatable embossing cylinders may be identical.

According to some embodiments, the first heatable embossing roll is configured to form the first embossments with a height of 0.1 mm to 1.2 mm on the first ply, and the second heatable embossing roll is configured to form the second embossments with a height of 0.2 mm to 2.0 mm on the second ply, wherein the height of the second embossments is larger than the height of the first embossments. In other words, (at least some of) the heights of the embossing protrusions on the first heatable embossing cylinder may be lower than the height of (at least some of) the heights of the embossing protrusions on the second heatable embossing cylinder.

The first heatable embossing cylinder may be configured to create embossments of a type which are often referred to as microembossments and typically have heights in a range of 0.1 mm to 1.2 mm. The second heatable embossing cylinder may be configured to create embossments of a type which are often referred to as macroembossments and typically have heights in a range of 0.2 mm to 2.0 mm.

The first heatable embossing roll may be configured to be heated to a steady-state temperature in the range of 80° C. to 170°, optionally 100° C. to 165°, 110° C. to 165°, 120° C. to 160°, or 130° C. to 155°. These temperature ranges may, to an increasing degree with increasingly narrower ranges, promote being able to produce tissue paper products with an increased (cross-and/or main direction) tensile strength as compared to reference products which are made the same way but without using heated embossing rolls. The strength increase may be in a range of about 5-25% or even 20-25%. In addition or alternative thereto, a gain in absorption capacity of about 15% and/or an increase in cross-directional (CD) tensile strength of about 5-10% may be achieved, while (for each case) the softness of the product may not be decreased or only insignificantly decreased with respect to the respective reference product.

The references to the “steady-state temperatures” are references, in particular, to surface temperatures of the embossing roll. These may be measured, for example, using an infrared thermometer. Moreover, the temperature values refer to temperatures in the steady state of the manufacturing apparatus, i.e., not while running and while plies are in contact with the embossing rolls. In particular, the surface temperature of the heatable embossing roll may drop during manufacturing, due to various effects such as heat conduction to the ply in contact with the roll, etc. For example, a surface temperature of 170° C. might be measured in the steady state (when the embossing roll is not in contact with a ply), and this temperature might decrease to a temperature in the range of 100° C. to 130° C. during manufacturing, etc.

The second heatable embossing roll may be configured to be heated to a temperature in the range of 80° C. to 170°, optionally 100° C. to 165°, 110° C. to 165°, 120° C. to 160°, or 130° C. to 155°. These temperature ranges may, to an increasing degree with increasingly narrower ranges, promote being able to produce tissue paper products with an increased (cross-and/or main direction) tensile strength as compared to reference products which are made the same way but without using heated embossing rolls. The strength increase may be in a range of about 5-25% or even 20-25%. In addition or alternative thereto, a gain in absorption capacity of about 15% and/or an increase in cross-directional (CD) tensile strength of about 5-10% may be achieved, while (for each case) the softness of the product may not be decreased or only insignificantly decreased with respect to the respective reference product.

According to some embodiments, the apparatus further comprises at least one multi-ply-bonding unit configured to ply-bond a two-ply product formed by the embossing unit with at least one additional ply. Some embodiments may also comprise additional bonding units. In other words, the embossing unit in accordance with any one of the embodiments described above may be incorporated in an apparatus configured to produce a ply product with a larger number of plies than two, such as, in particular a tissue paper product with between three and seven plies in total.

Some embodiments of the apparatus for manufacturing a tissue paper product may comprise at least one wetting unit configured to wet at least one ply before the at least one ply is received by the embossing unit. This at least one ply may be the first ply or the second ply, or both the first ply as well as the second ply may be wettable, either with one and the same wetting unit or with a respective first and second wetting unit. Embodiments of the apparatus may also comprise more than two wetting units.

Each of the wetting units included in the apparatus may be configured to provide a liquid, such as water or, for example, water provided with one or several additives such as softening agents and/or vitamins and/or scents, to the at least one ply with an amount of liquid in the range of 2% to 12% of the basis weight of the ply, or optionally 4% to 10% of the basis weight of the ply. According to some embodiments, the wetting unit is configured to spray the liquid onto the respective ply. The wetting in these ranges may, to an increasing degree with increasingly narrower ranges, promote high tensile strength, good softness properties, and absorption capacity in the manufactured tissue paper products.

Whenever reference is made to the “grammage” (or “basis weight”) in this text, reference is made to the basis weight (grammage) as determined by a test method following the principles set forth in standard EN ISO 12625-6:2016 for determining the basis weight. Test pieces of 50 cm² are punched from the sample sheet. Test pieces are chosen randomly from the entire sample and should be free of folds, wrinkles and any other deviating distortions. The pieces are conditioned at 23° C., 50% RH (Relative Humidity) for at least 2 hours. A pile of 20 pieces is weighed on a calibrated balance. The basis weight (grammage) is the weighed mass divided by the total area 1000 cm² (20×50 cm²) and recorded as mean value with standard deviations.

According to some embodiments, the apparatus does not comprise a wetting unit for providing a liquid to any of the plies. In other words, the apparatus may be configured to process the first ply and the second ply without wetting them with a liquid. Such embodiments may promote high tensile strength, good softness properties, and absorption capacity in the manufactured products.

Whenever reference is made to the “absorption capacity” in this text, reference is made to an absorption capacity measured as follows. The measurements are carried out using the basket immersion method. A test sample with a defined width and total mass is placed in a cylindrical basket which is dropped from a defined height over a water surface with deionized water in accordance with ISO 14487 (conductivity ≤0.25 mS/m at 25 C). The time is measured between when the basket is dropped until the test sample is fully wet. The average time recorded for a number of samples is the equated to the water absorption time. The amount of absorbed water is determined from the dry and wet weight of the test sample. Previous to the measurement, the test samples are to be conditioned a sufficient time under 23° C. and 50% relative humidity (see ISO 187-standard atmosphere for conditioning and testing tissue). The resulting water absorption capacity is reported in grams water per gram test piece to the nearest 0.1 g/g. The method is carried out in accordance with ISO 12625-8:2011 (water-absorption time and water-absorption capacity, basket-immersion test method).

Whenever reference is made to a “tensile strength” in this text, the tensile strengths in question can be measured and compared as dry tensile strengths following the standard EN ISO 12625-4:2005 or as wet tensile strengths following the standard ISO 12625-5:2005.

The dry strength is determined according to EN ISO 12625-4: 2005, Tissue Paper and Tissue Products, Part 4: Determination of width-related breaking strength, elongation at break and tensile energy absorption. For exemplary purposes, the tensile tester used for the measurement featured two clamps of 50 mm width. Each clamp can grip the test piece firmly, but without damage, along a straight line across the full width of the test piece (the clamping line). The distance between the clamping lines was set at 100 mm. For special tests, the distance is reduced if the available length of the sample is lower than 100 mm (e.g., toilet tissue in cross direction). The tissue paper product to be measured, i.e., two sheets of a single-ply or multi-ply product, was cut into test pieces of 50 mm wide with parallel edges. Each sheet was cut into two different types of test pieces by cutting in the machine direction and in the cross direction. The obtained test pieces were then conditioned in an atmosphere of 23° C., 50% RH (Relative Humidity) for at least 4 hours. The test piece to be measured was placed between the clamps without any strain, and such that any observable slack is eliminated. At the beginning, a pre-tensile force of 25 cN is applied (zero of stretch) then the elongation rate between the clamps was kept constant at 5 cm/min. The maximum tensile force required to break the test piece was obtained. The measurement was repeated with six test pieces and the values obtained were averaged. The dry tensile strength was calculated by means of the following formula: Mean dry tensile strength [N/m]=(mean maximum tensile force [N]/initial width of the test piece [mm])×10<3.

The wet strength was determined according to EN ISO 12625-5 Tissue Paper and Tissue Products, Part 5: determination of width-related wet load at break, 2005. (optionally the following description which follows the principles of the DIN NORM). For exemplary purposes, when experimentally verifying the wet strength of a product, the tensile test was accordingly performed by means of an electronic tensile test apparatus (Model 1122, Instron Corp., Canton, Mass., USA) with a constant rate of elongation of 50 mm/min using a Finch device. To prepare the test strips, 6 samples each having a length of 150 mm and a width of 50 mm were cut from the raw tissue (single ply) prepared in such a manner that the longitudinal direction of the test strips coincided with the machine direction (MD) or cross-direction (CD). The free clamping length when using the Finch clamp was about 50 mm. The test strip was secured with both ends in a clamp of the test apparatus. The other end (loop) formed in this way was placed around a pin and treated at 23° C. with distilled water until complete saturation. The depth of immersion of the loop formed by the test strip is at least 20 mm. The soaking duration (immersion time) is 15 s, the rate of elongation is set to a constant (50±2) mm/min, the measurement of the breaking strength is performed on the sample immersed in distilled water. Six test strips at a time were measured, the result being indicated as an arithmetic mean. To ensure that the wet strength of the samples has fully developed, which is particularly necessary in the case of samples in which additional wet-strength agents were used to boost wet strength, e.g., by their addition in the mass, the samples to be tested were always artificially aged before conducting the tensile test. Aging was effected by heating the samples in an air-circulating drying cabinet to (80±1)° C. for a period of 30 min. Six test strips at a time were measured, the result being indicated as an arithmetic mean.

This disclosure also relates to a machine for manufacturing a roll of a tissue paper product. The machine comprises the apparatus in accordance with any one or (in so far not mutually exclusive) any combination of the embodiments of the apparatus described above. Moreover, the machine further comprises a roll forming unit for winding up a final product and forming a roll of absorbent sheet product.

The roll forming unit may comprise a mandrel that is axially elastic. The material of which the mandrel is made (especially the part coming into contact with tissue paper product, may be flexible and elastic.

According to some embodiments, the apparatus may be used to manufacture tissue paper products (and the corresponding machine may be used to manufacture rolls comprising such tissue paper products) with micro-embossments and/or with decorative embossments. In particular, the tissue paper products may be manufactured to comprise at least one region within which a density of the micro-embossments is, in the area of this region where the tissue paper product does not comprise the decorative embossments, in a range of 25 to 120 dots/cm², optionally 40 to 100 dots/cm², or 50 to 80 dots/cm². According to some embodiments, the density of the micro-embossments is, in the area of the entire tissue paper product, where the tissue paper product does not comprise the decorative embossments, in a range of 25 to 120 dots/cm², optionally 40 to 100 dots/cm², or 50 to 80 dots/cm². These densities may, to an increasing degree for narrower ranges, promote high strength and good absorption properties of the respective tissue paper product.

According to some embodiments, a top ply of a manufactured tissue paper product may include one or two types of embossments, being decorative embossments with an embossing height in a range of 0.2 mm to 2.0 mm, optionally 0.8 mm to 1.4 mm, and/or micro-embossments with an embossing height in a range of 0.1 mm to 1.2 mm. The decorative embossments may be provided with a density of 15 dots/cm² or less, optionally 10 dots/cm² or less.

According to some embodiments, a bottom ply of a manufactured tissue paper product may include one or two types of embossments, being decorative embossments with an embossing height in a range of 0.2 mm to 2.0 mm, optionally 0.8 mm to 1.4 mm, and/or micro-embossments with an embossing height in a range of 0.1 mm to 1.2 mm. The decorative embossments may be provided with a density of 15 dots/cm² or less, optionally 10 dots/cm² or less.

Micro-embossments and/or decorative embossments may be in the form of lines or dots or other shapes. In the case that the decorative embossments are dot-shaped, the density may be lower than 10 embossments/cm² for the decorative embossments.

Another aspect of this disclosure relates to a method of manufacturing a tissue paper product, such as toilet paper or household towel, comprising at least two plies.

Embodiments of the method comprise the steps of:
feeding at least a first ply and a second ply, with a basis weight in a range of 13 to 30 g/m², respectively;
receiving the first ply and the second ply by an embossing unit comprising a first counter roll, a first heatable embossing roll heated to a temperature in a range of 80° C. to 170° C., a second counter roll, a second heatable embossing roll heated to a temperature in a range of 80° C. to 170° C., and a marrying roll;
embossing the first ply between the first heatable embossing roll and the first counter roll and embossing the second ply between the second heatable embossing roll and the second counter roll; and
ply-bonding the first ply and the second ply between the first heatable embossing roll and the marrying roll.

According to some embodiments, the first heatable embossing roll and the second heatable embossing roll are synchronized, and the first ply and the second ply are ply-bonded with a nested embossment structure or with a tip-to-tip bonding structure.

The described steps may offer an efficient way of ply-bonding on the basis of a manufacturing process relying on heat-embossing and reaching a nested embossment structure or a tip-to-tip bonding structure of the ply-bonded plies.

The basis weight of the first ply may be in a range of 16 to 28 g/m², or from 18 to 24 g/m² or from 18 to 22 g/m². The range of 13 to 30 g/m² and, to an increasing degree with the increasingly narrower ranges, may be particularly useful with the method for producing a tissue paper product with high tensile strength and high softness, as well as good absorption capacity. In particular, the tensile strength and the good absorption capacity of the manufactured tissue paper products may be higher than for reference products manufactured with the same plies and under the same conditions, with the exception of not using heated embossing rolls for the embossing steps (that is, in particular, with respect to corresponding reference products with the same thickness).

The basis weight of the second ply may be in a range of 16 to 28 g/m², or from 18 to 24 g/m² or from 18 to 22 g/m². The range of 16 to 28 g/m² and, to an increasing degree with the increasingly narrower ranges, may be particularly useful with the method for producing a tissue paper product with high tensile strength and high softness, as well as good absorption capacity. In particular, the tensile strength and the good absorption capacity of the manufactured tissue paper products may be higher than for reference products manufactured with the same plies and under the same conditions, with the exception of not using heated embossing rolls for the embossing steps (that is, in particular, with respect to corresponding reference products with the same thickness).

According to some embodiments, the method comprises the steps of:
receiving the first ply with the first counter roll;
conveying the first ply between the first counter roll and the first heatable embossing roll;
further conveying the first ply with the first counter roll;
receiving the second ply with the second counter roll;
conveying the second ply between the second counter roll and the second heatable embossing roll;
further conveying the second ply with the second counter roll; and
conveying the first ply and the second ply between the first heatable embossing roll and the marrying roll to ply-bond the first ply and the second ply with each other;
wherein the first counter roll, the second heatable embossing roll, and the marrying roll are rotated in one direction, and the second counter roll and the first heatable embossing roll are rotated in another direction, opposite to the one direction.

The described steps may offer an efficient way of ply-bonding on the basis of a manufacturing process relying on heat-embossing and reaching a nested embossment structure of the ply-bonded plies.

The method may comprise the step of applying an adhesive, such as lamination glue, to the first ply and/or to the second ply, prior to the step of ply-bonding the first ply and the second ply. This may ensure that the ply-bonding can be carried out reliably. In particular, the adhesive may be applied shortly prior to the ply-bonding step such that the adhesive does not prematurely dry and that the ply-bonding is timely performed after application of the adhesive.

The adhesive may be supplied to at least a part of the tips of embossments formed on the first ply. The adhesive may be supplied to at least 80%, 85%, 90%, 95% or even at least 99% of the tips of embossments formed on the first ply. The embossments, where the adhesive is applied, may be the only type of embossments on the first ply, or it may be only one amongst two or more types of embossments, or it may be two (or any larger number) of different embossments formed on the first ply. The embossments, where the adhesive is applied, may at least include the deepest embossments if there are embossments with different depths.

The adhesive may be supplied to at least a part of the tips of embossments formed on the second ply. The adhesive may be supplied to at least 80%, 85%, 90%, 95% or even at least 99% of the tips of embossments formed on the second ply. The embossments, where the adhesive is applied, may be the only type of embossments on the second ply, or it may be only one amongst two or more types of embossments, or it may be two (or any larger number) of different embossments formed on the second ply. The embossments, where the adhesive is applied, may at least include the deepest embossments if there are embossments with different depths.

The adhesive may be supplied to the first ply while the first ply is being conveyed by the first heated embossing unit prior to the ply-bonding. Supplying the adhesive in this way may ensure that the ply-bonding takes place sufficiently quickly after supplying the adhesive and such that the ply-bonding can be effectively carried out. In particular, the application of the adhesive in this way may enable heat-embossing as well as ply-bonding at a high processing speed. Applying the adhesive to the first ply while the first ply is being conveyed by the first heated embossing unit may be particularly beneficial as the ply-bonding takes place between the first heatable embossing roll and the marrying roll. The latter implies that the time span between the application of the adhesive and the ply-bonding can be minimized by applying the adhesive while the first ply is being conveyed by the first heatable embossing roll.

The adhesive may be supplied to the second ply while the second ply is being conveyed by the second heated embossing unit prior to the ply-bonding. Supplying the adhesive in this way may ensure that the ply-bonding takes place sufficiently quickly after supplying the adhesive and such that the ply-bonding can be effectively carried out. In particular, the application of the adhesive in this way may enable heat-embossing as well as ply-bonding at a high processing speed.

According to some embodiments, the adhesive is transferred from an anilox roll, engraved with cavities for receiving respective dosages of adhesive and for dosage of adhesive to an applicator roll, and the adhesive is supplied from the applicator roll to the first ply or the second ply. This allows both precisely dosing the adhesive by virtue of the anilox roll as well as homogeneously distributing it to the first ply or the second ply by virtue of the applicator roll.

In accordance with any one or several of the embodiments, the plies may be processed a speed in a range of 200 m/min to 700 m/min. At a speed of least 200 m/min, the combination of heat-embossing and ply-bonding may be ensured to be carried out at a satisfactory level of reliability. In other words, processing speeds of at least 200 m/min may be required to ensure the quality of the ply-bonding. According to some embodiments, the processing speed may be at least 300 m/min or even at least 400 m/min to ensure particularly reliable ply-bonding.

Moreover, it may be particularly beneficial to the reliability of the manufacturing process and/or to the quality of the manufactured tissue paper products, if the mentioned processing speeds are combined with the supplying of the adhesive to the first ply while the first ply is being conveyed by the first heatable embossing roll.

According to some embodiments, the first ply is made of one of the materials selected from the group consisting of: CWP and structured tissue such as creped TAD, uncreped TAD, eTAD, NTT, and ATMOS. Alternatively, or in addition thereto, the second ply may be made of one of the materials selected from the group consisting of: CWP and structured tissue such as creped TAD, uncreped TAD, eTAD, NTT, and ATMOS. It may be particularly desirable to choose at least one of the plies or even both plies to be made of CWP.

The method may comprise the steps of feeding a third ply, and ply-bonding the third ply with the first ply or the second ply, simultaneously with (or prior to or after) any of the above-described the steps carried out in the embossing unit. This way, the method may, e.g., allow producing tissue paper products with three plies. According to some embodiments, further plies are added. The method may, hence, be used to produce products with higher number of plies. Specifically, the method may be used to produce tissue paper products comprising 2, 3, 4, 5, or 6 plies.

The third ply may be made of one of the materials selected from the group consisting of: CWP and structured tissue such as creped TAD, uncreped TAD, eTAD, NTT, and ATMOS.

According to some embodiments, the first heatable embossing roll is heated to a temperature in the range of 80° C. to 170°. This may allow a reliable heat-embossing to be carried out and may allow achieving high tensile strength tissue paper products, with sufficient thickness, and good absorption capacity, without lowering (or while hardly lowering) the softness, as compared to a respective reference product produced in an analogous manner with the exception of not using heat-embossing but embossing with a non-heated roll. These mentioned properties may increasingly be improved by choosing an increasingly narrower temperature range to which the first heat embossing roll is heated, i.e., 100° C. to 165°, 110° C. to 165°, 120° C. to 160°, or 130° C. to 155°.

According to some embodiments, the second heatable embossing roll is heated to a temperature in the range of 80° C. to 170°. This may allow a reliable heat-embossing to take place and may allow achieving high tensile strength tissue paper products, with sufficient thickness and good absorption capacity, without lowering (or while hardly lowering) the softness, as compared to a respective reference product produced in an analogous manner with the exception of not using heat-embossing but embossing with a non-heated roll. These mentioned properties may increasingly be improved by choosing an increasingly narrower temperature range to which the second heat embossing roll is heated, i.e., 100° C. to 165°, 110° C. to 165°, 120° C. to 160°, or 130° C. to 155°.

The method may comprise a step of wetting the first ply and/or the second ply with a liquid prior to embossing the first ply and/or second ply in the embossing unit. This may further promote achieving high thickness, not (or hardly) lowering softness, high tensile strength, and/or good absorption capacity in the manufactured tissue paper products, as compared to reference products (not relying on heat-embossing and/or reference products produced without a wetting step).

A wetting step may be carried out by spraying a liquid, such as water, onto the respective ply.

A wetting step may comprise adding the liquid, such as water, to the first ply and/or the second ply with an amount of liquid in the range of 2% to 12% of the basis weight of the ply, or optionally 4% to 10% of the basis weight of the first ply and/or the second ply.

Some embodiments of the method do not comprise a step of wetting a ply with a liquid. The manufactured tissue paper tissue paper products may have high thickness, not (or hardly) lowered softness (as compared to reference products produced without heat-embossing), high tensile strength, and/or good absorption capacity (as compared to reference products produced without heat-embossing).

An embossing load during the embossing of the first ply may be in a range of 1 to 50 kg/cml, or it may even be in a range of 5 to 40 kg/cml. These ranges may, to an increasing degree with the narrower range, promote high thickness, not (or hardly) lowered softness (as compared to reference products produced without heat-embossing), high tensile strength, and/or good absorption capacity (as compared to reference products produced without heat-embossing).

An embossing load during the embossing of the second ply may be in a range of 1 to 50 kg/cml, or it may even be in a range of 5 to 40 kg/cml. These ranges may, to an increasing degree with the narrower range, promote high thickness, not (or hardly) lowered softness (as compared to reference products produced without heat-embossing), high tensile strength, and/or good absorption capacity (as compared to reference products produced without heat-embossing).

According to embodiments, an embossing density of embossments formed on a ply being embossed may be in a range of 3 to 5 embossments per cm², optionally 3.5 to 4.5 embossments per cm². A height of embossments formed may lie in a range of 0.8 mm to 1.4 mm. An embossing density may be measured, e.g., using 3D tomography (for example, using Alicona Infinite Focus SL with the software IF-MeasureSuite Version 5.1). Alicona Infinite Focus SL with the software IF-MeasureSuite Version 5.1 may also be used to measure a surface area that has been embossed and/or an embossment height. The embossment height may be defined as a distance from a bottom of the ply to a top of the ply in sectional view.

This disclosure also relates to a tissue paper product, such as toilet paper or household towel, manufactured according to any one or any combination of the embodiments of the method in accordance with the present disclosure described above.

Moreover, this disclosure also relates to a roll of a tissue paper product, such as toilet paper or household towel, comprising the tissue paper product manufactured according to any one or any combination of the embodiments of the method in accordance with the present disclosure. A diameter of the roll may be in a range of from 80 to 200 mm, optionally from 100 to 150 mm. The roll may be a roll of household towel.

Additional advantage and features of the present disclosure, that can be realized on their own or in combination with one or several features discussed above, insofar as the features do not contradict each other, will become apparent from the following description of particular embodiments.

### BRIEF DESCRIPTION OF THE DRAWINGS

For a better understanding of the present disclosure and to show how the same may be carried into effect, reference will now be made, by way of example only, to the accompanying drawings, in which:

The description is given with reference to the accompanying drawings, in which:

FIG. 1 depicts an embodiment of an embodiment of an apparatus for manufacturing a tissue paper product in accordance with the present disclosure; and

FIG. 2 is an enlarged part of a part of the apparatus of FIG. 1 showing how ply-bonding is carried out between a heatable embossing roll and a marrying roll.

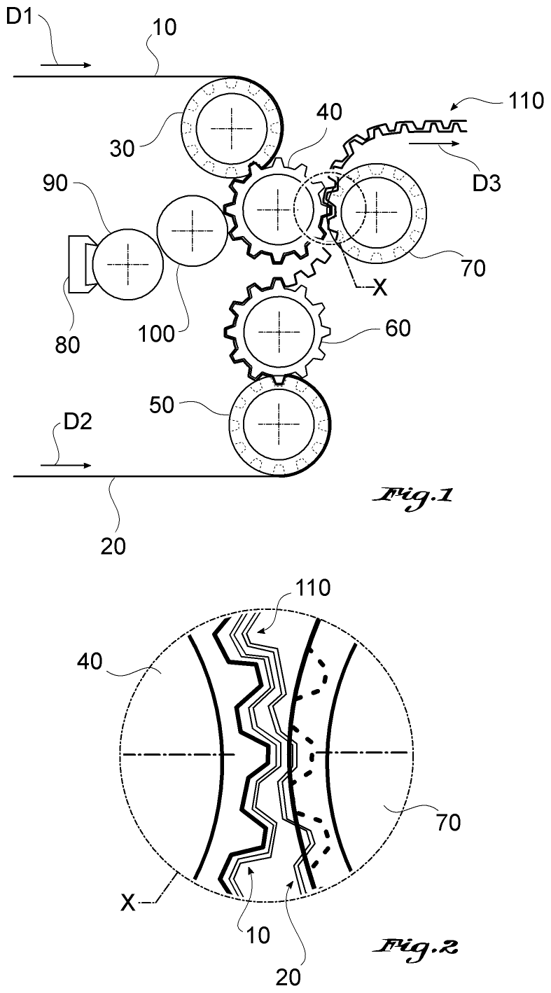

FIG. 1 depicts an embodiment of an embodiment of an apparatus for manufacturing a tissue paper product in accordance with the present disclosure. To be more precise, FIG. 1 depicts an embossing unit of the apparatus.

The embossing unit shown in FIG. 1 comprises a first heatable embossing roll 40 and a second heatable embossing roll 60. The first heatable embossing roll 40 and the second heatable embossing roll 60 are both heatable to a temperature in a range of 80° C. to 170° C. with an inner heating means (not shown in FIG. 1 and provided inside of the first and second heatable embossing rolls 40, 60, respectively), heating the respective roll from the inside. In accordance with other embodiments, an outer heating means may be provided, which heats the respective roll from the outside. According to some embodiments, a roll may be heated both from the inside and from the outside.

The embossing unit further comprises a first counter roll 30 and a second counter roll 50.

When using the apparatus, and when using the embossing unit of FIG. 1, in particular, a first ply 10 is received by the first counter roll 30 and conveyed by the first counter roll 30, until the first ply 10 is embossed between the first counter roll 30 and the first heatable embossing roll 40. Although it is possible, in the case of this embodiment, not to heat the first heatable embossing roll 40, it is of particular interest to heat the first heatable embossing roll 40 to a temperature in the range of 80° C. to 170° C. and to heat-emboss the first ply 10 between the first counter roll 30 and the first heatable embossing roll 40. The first ply 10 is received at a processing speed D1 in the range of 200 m/min to 700 m/min.

When using the apparatus, and when using the embossing unit of FIG. 1, in particular, a second ply 20 is received by the second counter roll 50 and conveyed by the first counter roll 50, until the second ply 20 is embossed between the second counter roll 50 and the second heatable embossing roll 60. Although it is possible, in the case of this embodiment, not to heat the second heatable embossing roll 60, it is of particular interest to heat the second heatable embossing roll 60 to a temperature in the range of 80° C. to 170° C. and to heat-emboss the second ply 20 between the second counter roll 50 and the second heatable embossing roll 60. The second ply 20 is received at a processing speed D2 in the range of 200 m/min to 700 m/min.

Specifically, the apparatus of FIG. 1 allows synchronizing the first heatable embossing roll 40 and the second heatable embossing roll 60. For example, the first ply 10 and the second ply 20 are processed at the same processing speed D1 and D2 in the range of 200 m/min to 700 m/min. D1 and D2 may be the same or may be deviate from one another. The synchronization of the first heatable embossing roll 40 and the second heatable embossing roll 60 allows ply-bonding the first ply 10 and the second ply 20 in a next step in a nested manner, i.e., such that embossments on the first ply 10 and on the second ply 20 are nested (received in one another). Alternatively, the embodiment of FIG. 1 also allows to form a tip-to-tip bonding structure or to be operated without synchronization such that the plies are bonded, e.g., with a random nested structure.

The apparatus of FIG. 1 comprises a marrying roll 70 and is configured to ply-bond the first ply 10 and the second ply 20 between the first heatable embossing roll 40 and the marrying roll 70. At the right-hand side of FIG. 1, the nested embossment structure 110 of the ply-bonded product with two plies, conveyed at the processing speed D3, which is in this case equal to D1 and D2, is schematically shown.

FIG. 2 is an enlarged view of region X of FIG. 1, i.e., the region X where the ply-bonding of the first ply 10 and the second ply 20 is carried out. The first heatable roll 40 and the marrying roll 70 ply-bond the two plies 10, 20 such that the embossments are nested in one another. To ensure this, the first heatable roll 40 and the second heatable roll 60 are synchronized during the manufacturing process. This may imply that the processing speeds D1 and D2 are the same, or it may imply that the speeds D1, D2 differ.

Turning back to FIG. 1, it can further be seen that the embodiment of the apparatus comprises an adhesive supplying unit. The adhesive supplying unit supplies adhesive to the first ply 10 while the first ply 10 is being conveyed by the first heated embossing unit 40, just after the heat-embossing has taken place and prior to the ply-bonding with the second ply 20. The adhesive is thus supplied just shortly before the ply-bonding. This means that the heating of the first ply 10 does not negatively affect the ply-bonding process.

The adhesive is supplied to at least a part of the tips of the embossments formed between the first counter roll 30 and the first heatable embossing roll 30 on the first ply 10.

The adhesive supplying unit comprises an applicator roll 100 for homogeneously transferring adhesive to the first ply 10, and an anilox roll 90 for dosing adhesive and transferring the adhesive to the applicator roll 100. The anilox roll 90 is engraved with cavities (not shown in FIG. 1) for receiving respective dosages of adhesive from an adhesive storage part 80.

The tissue paper products comprising the two plies 10, 20 with the nested embossment structure 110 and formed using heat-embossing with the first heatable embossing roll 40 and the second heatable embossing roll 60 both heated to a temperature in a range of 80° C. to 170° C. while the heat-embossing is performed, may have a high CD (cross direction) and/or MD (main direction) tensile strength, large thickness and good absorption capacity, without lowering (or while hardly lowering) the softness, as compared to a respective reference product produced in an analogous manner with the exception of not using heat-embossing but embossing with a non-heated roll.

In the following, a number of comparisons between tissue paper products manufactured using an embodiment of an apparatus in accordance with the present disclosure and an embodiment of a method in accordance with the present disclosure with reference products will be discussed.

### EXAMPLE 1

Household towel products made of two plies of Conventional Wet Press (CWP) paper were produced with a grammage of about 40 g/m² using an apparatus in accordance with the present disclosure and, in particular, using an embossing unit with two heatable embossing rolls. Both rolls were heated to a temperature in the range of 100 ° C. to 150 ° C. The processing speed was in a range of 200 m/min to 700 m/min. The embossing load was varied, in order to make products of different thicknesses. Various properties of the manufactured tissue paper products were measured.

Both plies were embossed with an embossing density of 4 dots/cm² and with embossment heights in a range of 0.8 mm to 1.4 mm. The embossments covered a surface area of the respective ply amounting to 5.2% of the total surface area of the respective ply.

A comparison was performed with reference products produced under the same conditions, with the exception of not heating any of the embossing rolls. It was found that the tissue paper product produced using the heated embossing rolls had a cross directional (CD) wet strength that was about 25% higher than the respective reference product.

Experimental results comparing the “reference products” and tissue paper products produced using embossing rolls to 100° C., 140° C., and 160° C. and having different thicknesses are shown in the following graph:

A comparison of the absorption capacities (measured in g/g) is shown in the following graph:

### EXAMPLE 2

Household towel products made of two plies of TAD paper were produced with a grammage of about 40 g/m² using an apparatus in accordance with the present disclosure and, in particular, using an embossing unit with two heatable embossing rolls. Both rolls were heated to a temperature in the range of 100° C. to 150° C. The processing speed was in a range of 200 m/min to 700 m/min. The embossing load was varied, in order to make products of different thicknesses. Both plies were embossed with an embossing density of 4 dots/cm² and with embossment heights in a range of 0.8 mm to 1.4 mm. The embossments covered a surface area of the respective ply amounting to 5.2% of the total surface area of the respective ply. Various properties of the manufactured tissue paper products were measured.

A comparison was performed with reference products produced under the same conditions, with the exception of not using any heated embossing rolls. It was found that the tissue paper product produced using the heated embossing rolls had a cross directional (CD) wet strength that was about 5-10% higher than the respective reference product.

Experimental results comparing the “reference products” and tissue paper products produced using embossing rolls to 100° C., 140° C., and 160° C. and having different thicknesses are shown in the following graph:

Additional comparisons were made between analogous products which were produced using an additional step of wetting the plies with water (with 1.5 g/m² per ply) during the manufacturing process:

Also in this case, an increase of the CD strength of about 5-10% as compared to reference products was observed. The following graphs compares the geometric tensile strength (GMT) of products produced without wetting the plies, products produced with plies wet with 0.5 g/m² of water per ply water, and products produced with plies wet with 1.5 g/m² of water per ply:

The experimental results are summarized in the following table:

| | Thickness gain at similar | Absorption gain at similar CD |
|---|---|---|
| | CD wet versus no nested | wet versus no nested |
| | heating cylinder (%) | heating cylinder (%) |
| CWP | 10% | 15% |
| TAD | 5% | 4% |
| | CD wet gain at thickness | Absorption at thickness |
| | constant versus no nested | constant versus no nested |
| | heating cylinder (%) | heating cylinder (%) |
| CWP | 25% | 6% |
| TAD | 22% | 1% |

Moreover, the reduction of the softness compared to the respective reference products was evaluated:

| | Softness point reduction |
|---|---|
| CWP | −0.5 (from 4.5 to 4) |
| TAD | −0.5 (from 7 to 6.5) |
| CWP | −0.5 (from 4.5 to 4) |
| TAD | −0.5 (from 7 to 6.5) |

It will be apparent to those skilled in the art that various modifications and variations can be made in the disclosed devices and systems without departing from the scope of the disclosure. Other aspects of the disclosure will be apparent to those skilled in the art from consideration of the specification and practice of the features disclosed herein. It is intended that the specification and examples be considered as exemplary only. Many additional variations and modifications are possible and are understood to fall within the framework of the disclosure.

1-29. (canceled)

30. An apparatus for manufacturing a tissue paper product, such as toilet paper or household towel, the apparatus comprising:
an embossing unit comprising a first counter roll, a first heatable embossing roll, a second counter roll, and a second heatable embossing roll, and a marrying roll,
wherein the apparatus is configured to emboss a first ply between the first heatable embossing roll and the first counter roll, and to emboss a second ply between the second heatable embossing roll and the second counter roll, and to ply-bond the first ply and the second ply between the first heatable embossing roll and the marrying roll, and
the apparatus is configured to process at a ply speed in a range of 300 m/min to 700 m/min,
wherein, optionally, the first heatable embossing roll and the second heatable embossing roll are synchronizeable for ply-bonding the first ply and the second ply with a nested embossment structure or a tip-to-tip bonding structure.

31. The apparatus for manufacturing a tissue paper product of claim 30,
wherein the embossing unit is configured to receive the first ply with the first counter roll, to convey the first ply between the first counter roll and the first heatable embossing roll, and to further convey the first ply with the first heatable embossing roll, and
wherein the embossing unit is configured to receive the second ply with the second counter roll, to convey the second ply between the second counter roll and the second heatable embossing roll, and to further convey the second ply with the second heatable embossing roll,
wherein the embossing unit is configured to convey the first ply and the second ply between the first heatable embossing roll and the marrying roll.

32. The apparatus for manufacturing a tissue paper product of claim 30,
wherein the embossing unit comprises an adhesive supplying unit for applying adhesive, such as lamination glue, to the first ply and/or to the second ply,
the apparatus optionally being configured to supply the adhesive to at least a part of the tips of embossments formed on the first ply or the second ply,
wherein the adhesive supplying unit is optionally configured to supply adhesive to the first ply while the first ply is being conveyed by the first heated embossing unit prior to the ply-bonding, and/or wherein the adhesive supplying unit is optionally configured to supply adhesive to the second ply while being conveyed by the second heated embossing unit prior to the ply-bonding.

33. The apparatus for manufacturing a tissue paper product of claim 32, wherein the adhesive supplying unit comprises an applicator roll for transferring adhesive to the first ply or the second ply, and an anilox roll for dosing adhesive and transferring the adhesive to the applicator roll,
wherein the anilox roll is engraved with cavities for receiving respective dosages of adhesive.

34. The apparatus for manufacturing a tissue paper product of claim 30, the apparatus being configured to process at a ply speed in a range of 400 m/min to 700 m/min.

35. The apparatus for manufacturing a tissue paper product of claim 32, wherein the adhesive supplying unit is configured to supply adhesive to the first ply while the first ply is being conveyed by the first heatable embossing roll.

36. The apparatus for manufacturing a tissue paper product of claim 30, wherein the first counter roll, the second heatable embossing roll, and the marrying roll are rotatable in one direction and the second counter roll and the first heatable embossing roll are rotatable in another direction, opposite to the one direction.

37. The apparatus for manufacturing a tissue paper product of claim 30, wherein the first heatable embossing roll is configured to form first embossments with a height in a range of 0.2 mm to 2.0 mm on the first ply, and the second heatable embossing roll is configured to form second embossments with a height in a range of 0.2 mm to 2.0 mm on the second ply, and wherein the first heatable embossing roll is optionally configured to also form third embossments with a height that is smaller than the height of the first embossments, and/or wherein the second heatable embossing roll is optionally configured to also form fourth embossments with a height that is smaller than the height of the second embossments.

38. The apparatus for manufacturing a tissue paper product of claim 37, wherein the first heatable embossing roll is configured to form the first embossments with a height of 0.1 mm to 1.2 mm on the first ply, and the second heatable embossing roll is configured to form the second embossments with a height of 0.2 mm to 2.0 mm on the second ply, wherein the height of the second embossments is larger than the height of the first embossments.

39. The apparatus for manufacturing a tissue paper product of claim 30, wherein the first heatable embossing roll is configured to be heated to a steady-state temperature in the range of 80° C. to 170° C., optionally 100° C. to 165° C., or 110° C. to 165° C., and/or wherein the second heatable embossing roll is configured to be heated to a steady-state temperature in the range of 80° C. to 170° C., optionally 100° C. to 165° C., or 110° C. to 165° C.

40. The apparatus for manufacturing a tissue paper product of claim 39, wherein the first heatable embossing roll is configured to be heated to a steady-state temperature in the range of 120° C. to 160° C., or optionally 130° C. to 155° C., and wherein the second heatable embossing roll is configured to be heated to a steady-state temperature in the range of 120° C. to 160° C., or optionally 130° C. to 155° C.

41. The apparatus for manufacturing a tissue paper product of claim 30, the apparatus further comprising at least one multi-ply-bonding unit configured to ply-bond a two-ply product formed by the embossing unit with at least one additional ply.

42. The apparatus for manufacturing a tissue paper product of claim 30, the apparatus further comprising at least one wetting unit configured to wet at least one ply before the at least one ply is received by the embossing unit,
the wetting unit optionally being configured to provide a liquid, such as water, to the at least one ply with an amount of liquid in the range of 2% to 12% of the basis weight of the at least one ply, or optionally 4% to 10% of the basis weight of the at least one ply.

43. The apparatus for manufacturing a tissue paper product of claim 30, the apparatus lacking a wetting unit for providing a liquid to any of the plies.

44. A machine for manufacturing a roll of a tissue paper product, the machine comprising the apparatus of claim 30,
the machine further comprising a roll forming unit for winding up a final product and forming a roll of absorbent sheet product, the roll forming unit optionally comprising a mandrel that is axially elastic, the material of the mandrel optionally being flexible and elastic.

45. A method of manufacturing a tissue paper product, such as toilet paper or household towel, comprising at least two plies, comprising the steps of:
feeding at least a first ply and a second ply, with a basis weight in a range of 13 to 30 g/m², optionally from 16 to 28 g/m², or from 18 to 24 g/m² or from 18 to 22 g/m², respectively;
receiving the first ply and the second ply by an embossing unit comprising a first counter roll, a first heatable embossing roll heated to a steady-state temperature in a range of 80° C. to 170° C., a second counter roll, a second heatable embossing roll heated to a steady-state temperature in a range of 80° C. to 170° C., and a marrying roll;
embossing the first ply between the first heatable embossing roll and the first counter roll and embossing the second ply between the second heatable embossing roll and the second counter roll;
ply-bonding the first ply and the second ply between the first heatable embossing roll and the marrying roll;
wherein, optionally, the first heatable embossing roll and the second heatable embossing roll are synchronized and the first ply and the second ply are ply-bonded with a nested embossment structure or a tip-to-tip bonding structure
wherein the plies are processed at a speed in a range of 300 m/min to 700 m/min.

46. The method of manufacturing a tissue paper product of claim 45, comprising the steps of:
receiving the first ply with the first counter roll;
conveying the first ply between the first counter roll and the first heatable embossing roll;
further conveying the first ply with the first counter roll;
receiving the second ply with the second counter roll;
conveying the second ply between the second counter roll and the second heatable embossing roll;
further conveying the second ply with the second counter roll; and
conveying the first ply and the second ply between the first heatable embossing roll and the marrying roll to ply-bond the first ply and the second ply with each other;
wherein the first counter roll, the second heatable embossing roll, and the marrying roll are rotated in one direction and the second counter roll and the first heatable embossing roll are rotated in another direction, opposite to the one direction.

47. The method of manufacturing a tissue paper product of claim 45, the method further comprising the step of applying an adhesive, such as lamination glue, to the first ply and/or to the second ply, prior to the step of ply-bonding the first ply and the second ply,
wherein the adhesive is optionally supplied to at least a part of the tips of embossments formed on the first ply or the second ply,
wherein the adhesive is optionally supplied to the first ply while the first ply is being conveyed by the first heated embossing unit prior to the ply-bonding, and/or wherein the adhesive supplying unit is optionally configured to supply adhesive to the second ply while being conveyed by the second heated embossing unit prior to the ply-bonding.

48. The method of manufacturing a tissue paper product of claim 47, wherein the adhesive is transferred from an anilox roll, engraved with cavities for receiving respective dosages of adhesive and for dosage of adhesive to an applicator roll, and is supplied from the applicator roll to the first ply or the second ply.

49. The method for manufacturing a tissue paper product of claim 45, wherein the plies are processed at a speed in a range of 400 m/min to 700 m/min.

50. The method of manufacturing a tissue paper product claim 45, wherein the adhesive is supplied to the first ply while the first ply is being conveyed by the first heatable embossing roll.

51. The method of manufacturing a tissue paper product of claim 45,
wherein the first ply is made of one of the materials selected from the group consisting of: CWP and structured tissue such as creped TAD, uncreped TAD, eTAD, NTT, and ATMOS; and
wherein the second ply is made of one of the materials selected from the group consisting of: CWP and structured tissue such as creped TAD, uncreped TAD, eTAD, NTT, and ATMOS.

52. The method of manufacturing a tissue paper product of claim 45, the method comprising the steps of:
feeding a third ply, optionally made of one of the materials selected from the group consisting of: CWP and structured tissue such as creped TAD, uncreped TAD, eTAD, NTT, and ATMOS; and
ply-bonding the third ply with the first ply or the second ply, prior to or after the steps carried out in the embossing unit.

53. The method of manufacturing a tissue paper product of claim 45, wherein the first heatable embossing roll is heated to a steady-state temperature in the range of 80° C. to 170°, optionally 100° C. to 165°, or 110° C. to 165°; and/or
wherein the second heatable embossing roll is heated to a steady-state temperature in the range of 80° C. to 170°, optionally 100° C. to 165°, or 110° C. to 165°.

54. The method for manufacturing a tissue paper product of claim 53, wherein the first heatable embossing roll is heated to a steady-state temperature in the range of 120° C. to 160° C., or optionally 130° C. to 155° C., and
wherein the second heatable embossing roll is be heated to a steady-state temperature in the range of 120° C. to 160° C., or optionally 130° C. to 155° C.

55. The method of manufacturing a tissue paper product of claim 45, the method comprising a step of wetting the first ply and/or the second ply with a liquid prior to embossing the first ply and/or second ply in the embossing unit,
the step of wetting optionally comprising adding the liquid, such as water, to the first ply and/or the second ply with an amount of liquid in the range of 2% to 12% of the basis weight of the first ply and/or the second ply, or optionally 4% to 10% of the basis weight of the first ply and/or the second ply.

56. The method of manufacturing a tissue paper product of claim 45, the method lacking a step of wetting a ply with a liquid.

57. The method of manufacturing a tissue paper product claim 45, wherein an embossing load during the embossing of the first ply and/or the second ply is in a range of 1 to 50 kg/cml, optionally in a range of 5 to 40 kg/cml.

58. The method of claim 45, wherein the first ply is provided with first embossments with a height in a range of 0.2 mm to 2.0 mm and/or with third embossments with a height in a range of 0.1 mm to 1.2 mm, and/or
wherein the second ply is provided with second embossments with a height in a range of 0.2 mm to 2.0 mm and/or with fourth embossments with a height in a range of 0.1 mm to 1.2 mm.

59. A tissue paper product, such as toilet paper or household towel, manufactured according to the method of claim 45.

60. A roll of a tissue paper product, such as toilet paper or household towel, comprising the tissue paper product of claim 59, wherein a diameter of the roll is in a range of from 80 to 200 mm, optionally from 100 to 150 mm.
